(19) United States
(12) Patent Application Publication
(10) Pub. No.: US 2005/0071124 A1
(43) Pub. Date: Mar. 31, 2005

(54) Operating state management system for machine tool

(75) Inventor: Masahiro Komatsu, Yamatokoriyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MORI SEIKI CO., LTD., Yamatokoriyama-shi (JP)

(21) Appl. No.: 10/948,175

(22) Filed: Sep. 24, 2004

(30) Foreign Application Priority Data
Sep. 29, 2003 (JP) 2003-337712

(51) Int. Cl. B23Q 3/155

(52) U.S. Cl. 702/182

(57) ABSTRACT

An operating state management apparatus (10) for performing centralized management of operating state data for machine tools (20) of all customers is connected to each of the machine tools (20) via a wireless communication network and the Internet (60). A service center PC (40) constantly connected to a private server (15) provided in the operating state management apparatus (10) is installed in a service center. The service center PC (40) displays a predetermined map on a large screen monitor installed in the service center. Based on the location information data of each machine tool (20) regularly supplied by e-mail, the service center PC (40) indicates, on the map, the location of each machine tool (20) as a point of a circular marker. The color of the marker can be changed depending on the operating condition of the machine tool (20).

### BACKGROUND OF THE INVENTION

1. Field of the Invention

The present invention relates to an operating state management system for performing centralized management of information on the operating state of machine tools.

2. Description of Related Art

In recent years, an operating state management system for machine tools has been established which performs centralized management of information on the operating state of machine tools sold by a machine tool manufacturer to customers so that necessary information can be supplied to the customers when needed. In such an operating state management system for machine tools, information on the operating state of the machine tools owned by the customers are collected and transmitted to an operating state management apparatus installed in the machine tool manufacturer through a network such as the Internet for storage in a database in the operating state management apparatus.

Such an operating state management system for machine tools is so designed that each of the customers can view the operating state related information of its own machine tool. Further, such a system is also designed so that a serviceman of a service center of the machine tool manufacturer can view the operating state related information of the machine tools of all the customers to utilize such information for the maintenance or troubleshooting of the machine tools.

Generally, when a service center of a machine tool manufacturer receives a phone call from a customer reporting a trouble in its own machine tool, a serviceman of the service center analyzes the trouble by obtaining detailed information on the trouble status from a person in charge of the maintenance of the machine tool and viewing the operating state related information of the machine tool by utilizing the above-described operating state management system. When the trouble cannot be dealt with by telephone, the serviceman needs to actually visit the site to perform the maintenance of the machine tool (see, for example, Japanese Unexamined Patent Publications No. 5-108140 (1993)).

However, a serviceman does not always know the locations of all the customers. Therefore, when the serviceman does not know the location of the customer from which the phone call has been received, the service man needs to find the address of the customer from a customer list and confirm the location of the customer on the map based on the address. Therefore, it takes considerable time before the serviceman arrives at the location of the machine tool, so that the maintenance of the machine tool cannot be started immediately.

### SUMMARY OF THE INVENTION

It is, therefore, an object of the present invention to provide an operating state management system for machine tools, which is capable of sending a serviceman to the location of a machine tool of a customer in a short time even when the serviceman does not know the location of the customer.

According to a first aspect of the present invention, there is provided a system for managing operating state of a machine tool by transmitting operating state related information obtained from the machine tool to an operating state management apparatus and storing the operating state related information in the operating state management apparatus. The system comprises display means for displaying the location of the machine tool on a predetermined map in a predetermined manner based on the location information of the machine tool.

Preferably, the manner of display changes depending on the operating state of the machine tool.

Preferably, when an alarm is generated in the machine tool, the content of the alarm is displayed as well.

Preferably, operating state of the machine tool is displayed by a predetermined operation.

As described above, in the operating state management system for machine tools according to the present invention, the location of the machine tool under management is displayed on a predetermined map in a predetermined manner. Therefore, even when a serviceman does not know the location of a machine tool, the serviceman need not perform a troublesome work such as finding the address of the customer from a customer list and confirming the location on the map based on the address. Therefore, the service man can arrive at the location of the machine tool and start the maintenance of the machine tool in a short time.

Further, in the case where the operating state management system is so configured as to change the manner of display depending on the operating state of the machine tool, the operating state of the machine tool can be found out in confirming the location of the machine tool.

Furthermore, in the case where the operating state management system is so configured as to display also the content of an alarm generated in the machine tool, the content of the alarm can be checked quickly.

Moreover, in the case where the operating state management system is so configured that the operating state of the machine tool is displayed by a predetermined operation, the serviceman, after confirming the location of the machine tool, can immediately start the analysis of the alarm based on the operating state of the machine tool, if any alarm is generated in the machine tool, for example. Particularly, when the operation history of the machine tool such as the history of alarms generated in the past, Gantt chart, or availability is displayed as the operating state of the machine tool, the area where the availability of the machine is high can be displayed and analyzed. Further, since the pattern of Gantt chart varies depending on the kind of machining, i.e., varies between mold machining and parts machining, for example, such information on operating state can be utilized for analyzing what kind of machining is mainly performed in each region. In this way, by mapping the information on machines, various kinds of statistics and analysis can be performed at appropriate timing.

The foregoing and other objects, features and effects of the present invention will become more apparent from the following description of the preferred embodiments with reference to the attached drawings.

### BRIEF DESCRIPTION OF THE DRAWINGS

FIG. 1 is a schematic view showing the structure of an operating state management system for machine tools according to an embodiment of the present invention;

FIG. 2 is a functional block diagram of a communication unit used for the operating state management system;

FIG. 3 is a schematic view of the operating state management system, mainly showing the structure of the operating state management apparatus.

FIG. 4 shows an image to be displayed on a large screen monitor in the operating state management system;

FIG. 5 shows an image to be displayed on a large screen monitor in the operating state management system;

FIGS. 6A and 6B each shows an image to be displayed on a large screen monitor in the operating state management system; and

FIG. 7 shows an image to be displayed on a large screen monitor in the operating state management system.

### DESCRIPTION OF THE PREFERRED EMBODIMENTS

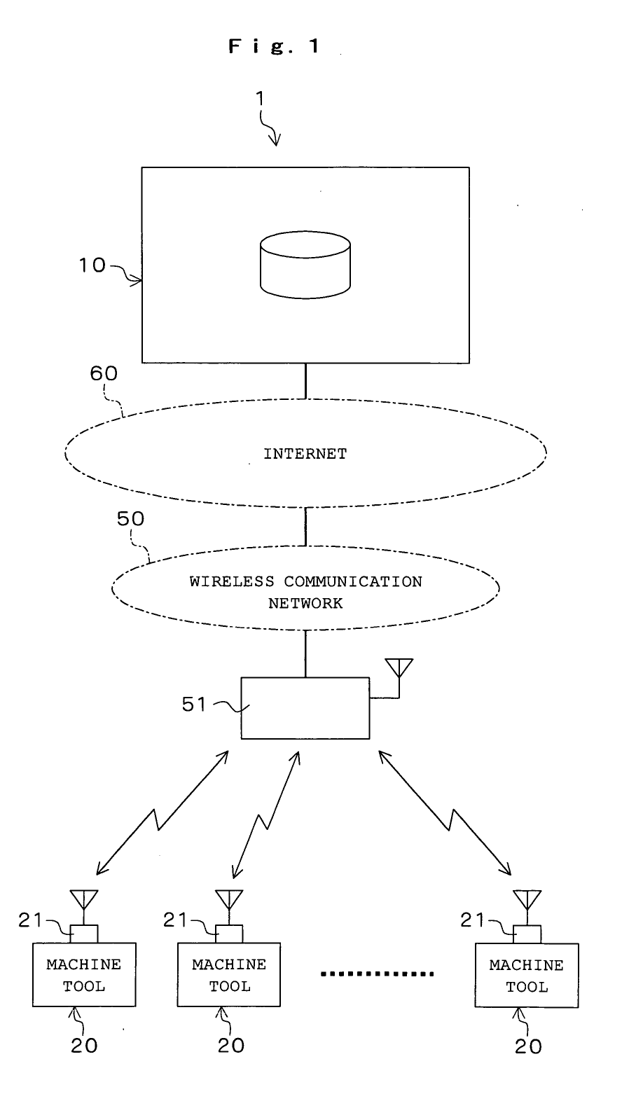

Preferred embodiments of the present invention will be described below with reference to the accompanying drawings. FIG. 1 shows an operating state management system 1 for machine tools which is so designed that a machine tool manufacturer can supply necessary information to customers when needed by performing centralized management of various information related to operating state of the machine tools sold by the manufacturer to the customers. The information managed by the operating state management system 1 can be utilized when a serviceman performs the maintenance or troubleshooting of the machine tools owned by the customers.

As shown in the figure, in the operating state management system 1, each of machine tools 20 owned by customers is connected, via a wireless communication network 50 and the Internet 60, to an operating state management apparatus 10 for performing the centralized management of operating state data of the machine tools 20. Each of the machine tools 20 is provided with a communication unit 21 which is capable of wirelessly communicating with a base station 51 connected to the wireless communication network 50.

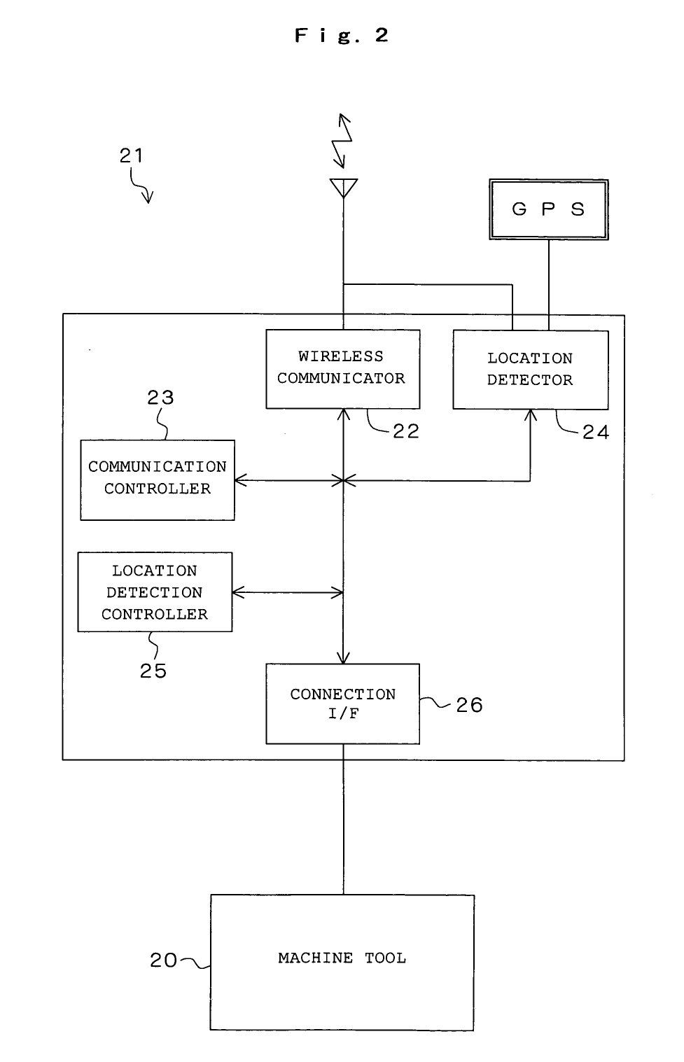

As shown in FIG. 2, the communication unit 21 comprises a wireless communicator 22, a communication controller 23, a location detector 24, a location detection controller 25 and a connection interface 26. The wireless communicator 22 wirelessly communicates with a base station 51 of the wireless communication network 50. The communication controller 23 issues, to the wireless communicator 22, a command to connect to the wireless communication network 50 (dial-up) and a command to connect to the Internet provider (PPP connection command) when communication is requested from the machine tool 20 side. The location detector 24 calculates the latitude and longitude of the installation location of the communication unit 21 based on a global positioning system (hereinafter referred to as “GPS”) or the latitude/longitude data and radio wave intensity of a plurality of base stations 51. The location detection controller 25 instructs the location detector 24 to obtain location information (latitude/longitude) when the obtainment of such location information is requested by the machine tool 20 side. The connection interface 26 connects the communication unit 21 and the machine tool 20 to each other for enabling data communication therebetween. When a data collection apparatus (not shown) incorporated in the machine tool 20 generates a location data obtainment command and transmits the location data obtainment command to the communication unit 21, the communication unit 21 obtains the location information by utilizing e.g. the GPS and transmits the location information to the data collection apparatus of the machine tool 20.

The data collection apparatus incorporated in each of the machine tools 20 automatically collects data for the operating state of the machine tool 20. The operating state data and the location information data collected by the data collection apparatus are regularly transmitted, along with the user ID for identifying the customer and the machine code for identifying the machine tool, to the operating state management apparatus 10 as e-mail and stored in the operating state management apparatus 10.

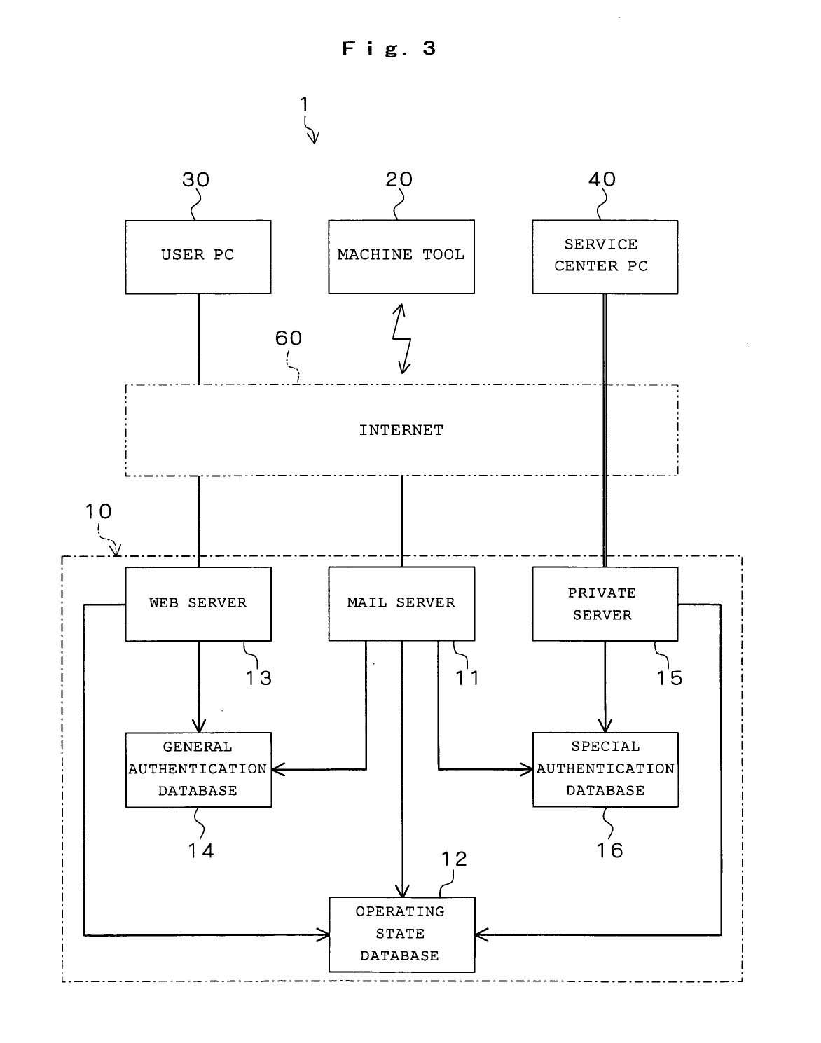

As shown in FIG. 3, the operating state management apparatus 10 comprises a mail server 11 connected to the Internet 60 for receiving e-mail transmitted from each of the machine tools 20, an operating state database 12 for storing the operating state data and the location information data included in the e-mail received by the mail server 11, and a Web server 13 connected to the Internet 60 for transmitting a particular piece of operating state data stored in the operation state database 12 to a user PC 30 of a customer in accordance with a request from the customer. The operating state database 12 includes an operating state table in which the above-described operating state data is associated with machine codes and a location information table in which location information data such as latitude and longitude is associated with machine codes. When the mail server 11 receives e-mail and stores the operating state data relating to the machine tool 20 and included in the e-mail into the operating state database 12, the latitude and longitude of the location information data included in the e-mail is compared with the latitude and longitude already stored in the location information table. When there exists a difference exceeding the allowable range between respective latitudes and longitudes, the location information data such as latitude and longitude of the location information table is renewed.

When a customer wants to know the operating state of its own machine tool 20, the customer connects the user PC 30 to the Web server 13 via the Internet 60, whereby necessary operating state data can be downloaded from the operating state database 12 through the Web server 13. The downloaded operating state data can be displayed in various display modes by various display programs installed in the user PC 30.

In the operating state management system 1 for machine tools, to reliably provide a valid customer demanding information with the operating state data of its own machine tool 20 only, i.e. to prevent the operating state data for the machine tool 20 owned by a customer from leaking to a third party, the operating state management apparatus 10 includes a general authentication database 14. In the general authentication database 14, user authentication data such as the user ID or password of each customer for identifying the customer is registered, and the machine code of a machine tool 20 owned by each customer is registered in association with the user ID. When the user authentication data inputted by a customer in connecting the user PC 30 to the Web server 13 agrees with the user authentication data registered in the general authentication database 14, the customer is authenticated as a valid customer. In this case, the operating state data of the machine tool 20 corresponding to the machine code registered in association with the user ID of the customer is allowed to be transmitted to the user PC 30 via the Web server 13.

Further, in the operating state management system 1 for machine tools, special user authentication data such as a special user ID or a password is allocated to a serviceman of a service center so that the serviceman can view all the operating state data stored in the operating state database 12 to utilize the operating state data of the machine tool 20 owned by a customer for the maintenance or troubleshooting of the machine tool 20. For this purpose, separately from the Web server 13 connected to the Internet 60, the operating state management apparatus 10 includes a private server 15 to which only a personal computer 40 installed in a service center (hereinafter referred to as “service center PC”) is connected via a virtual private network (VPN), and a special authentication database 16 in which special user authentication data is registered and in which machine codes of all the customers registered in the general authentication database 14 are registered in association with the special user ID.

Therefore, in order for a serviceman to view the operating state data of machine tools 20 stored in the operating state database 12, the serviceman connects the service center PC 40 to the private server 15. When the special user authentication data inputted by the serviceman agrees with the special user authentication data registered in the special authentication database 16, the serviceman can view the operating state data of the machine tools 20 of all customers.

The operating state management system 1 for machine tools is provided with a service center PC 40 constantly connected to the private server 15. As shown in FIG. 4, this service center PC 40 displays a predetermined map MP on a large screen monitor installed in the service center, and also displays, on the monitor, respective locations of the machine tools 20 as points of circular markers M based on the location information data (latitude and longitude) for the machine tools 20 regularly transmitted by e-mail.

The scale of the map MP displayed on the large screen monitor can be changed freely. When the scale of the map is enlarged, with one of the markers M indicating a particular machine tool 20 being selected by using a pointing device, a mouse or a laser pointer, for example, an enlarged view of the area around the location of that machine tool 20 is displayed.

The marker M indicating the location of each machine tool 20 is so designed as to change its color depending on the operating condition of the relevant machine tool 20 based on the operating state data of the machine tool 20 transmitted by e-mail. For example, the marker M may be displayed in green when the machine tool 20 is in operation, displayed in black when the power is OFF, displayed in yellow when the machine tool 20 is stopped, and displayed in red when an alarm is generated. Therefore, in checking the location of the machine tool 20, a serviceman can know the operating condition of the machine tool 20 as well.

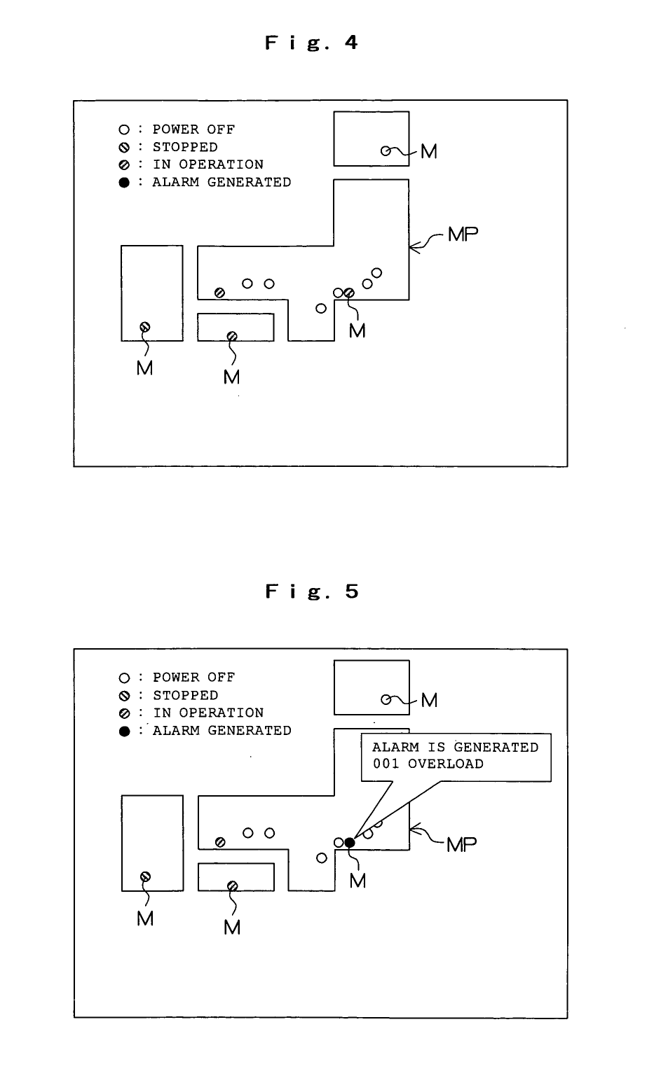

As shown in FIG. 5, when an alarm is generated in a machine tool 20, i.e., when the marker M is displayed in e.g. red, the content of the alarm is also displayed. Therefore, in checking the location of the machine tool 20 in which an alarm is generated, the serviceman can know the content of the alarm without performing any particular operation.

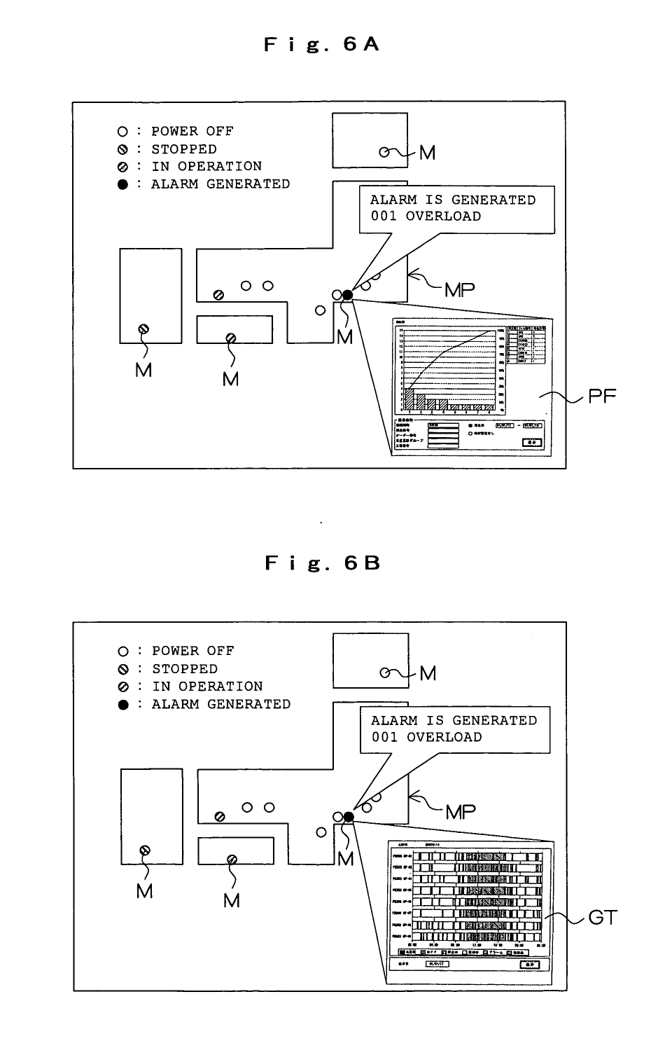

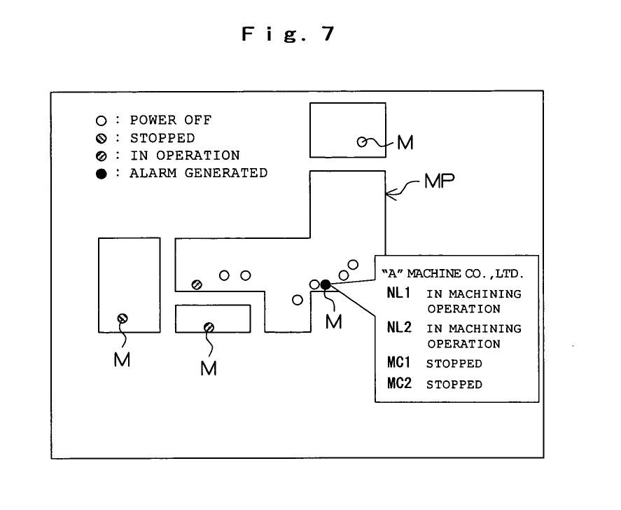

Further, when a marker M indicating a particular machine tool 20 is double-clicked with a pointing device, a mouse or a laser pointer, for example, the detailed information on the operating state of that machine tool 20, such as a Pareto chart PF (See FIG. 6A) showing the number of various kind of alarms generated or a Gantt chart GT (See FIG. 6B) showing the operation history is displayed. Therefore, after checking the location of the machine tool 20, the serviceman can immediately perform e.g. analysis of the cause of the alarm based on the operating state of the machine tool 20.

The above-noted various information displayed on the large screen unit can be viewed on the monitor of each service center PC 40 when a serviceman in charge of the service center PC 40 connects the service center PC 40 to the private server 15.

As noted above, in the operating state management system 1 for machine tools, respective locations of the machine tools 20 under management are indicated by markers M on the map MP. Therefore, even when a serviceman does not know the location of a machine tool 20, the serviceman need not perform a troublesome work such as finding the address of the customer from a customer list and confirming the location on the map based on the address. Therefore, upon receiving contact from the customer, the service man can arrive at the location of the machine tool 20 in a short time and start the maintenance of the machine tool 20.

In the embodiment described above, information on the locations of machine tools 20 owned by customers is regularly transmitted, by e-mail, to the operating state management apparatus 10 as location information data measured by the communication unit 21 having a location detection function. However, the present invention is not limited thereto. For example, the addresses etc. of the customers may be inputted in advance, and the locations of the machine tools 20 may be indicated on the map based on the addresses of the customers which own the machine tools 20.

Further, although the locations of the machine tools 20 owned by customers are indicated by circular markers M on the map MP in the above-described embodiment, the present invention is not limited thereto. For example, as the marker M, a marker having another shape such as a square or star-like shape or an icon may be used.

In the embodiment described above, when a marker M is double-clicked, a Pareto chart PF or a Gantt chart GT is displayed as the detailed information of the machine tool 20 indicated by the marker M. However, the present invention is not limited thereto, and the name of the customer or the model name of the machine tool may be displayed or the machine numbers and operating state of a plurality of machine tools 20 owned by the customer may be listed and displayed, as shown in FIG. 7. Particularly, in the case where the list showing a plurality of machine tools 20 owned by a customer is displayed, the marker M may be changed to red when an alarm is generated in any one of the listed machine tools 20.

In the embodiment described above, the color of each marker M is changed depending on the operating condition of the relevant machine tool 20. However, the present invention is not limited thereto, and the color of the marker M may be changed depending on the availability or the alarm generation rate, for example.

Although the operating state data etc. is transmitted by e-mail in the embodiment described above, the present invention is not limited thereto. For example, each machine tool 20 may be constantly connected to the operating state management apparatus 10 via the wireless communication network 50 or the Internet 60 so that the operation state data can be directly transmitted from the machine tool 20 to the operating state management apparatus 10.

In the embodiment described above, each machine tool 20 is connected to the Internet 60 via the wireless communication network 50 by utilizing the communication units 21 having location detection function. However, the present invention is not limited thereto. For example, a location detection unit for detecting the location by utilizing e.g. a GPS may be mounted to the machine tool 20, and direct wired connection of the machine tool 20 to the Internet 60 may be established.

While the present invention has been described in detail by way of the embodiment thereof, it should be understood that the foregoing disclosure is merely illustrative of the technical principles of the present invention but not limitative of the same. The spirit and scope of the present invention are to be limited only by the appended claims.

1. A system for managing operating state of a machine tool by transmitting operating state related information obtained from the machine tool to an operating state management apparatus and storing the operating state related information in the operating state management apparatus, the system comprising:
display means for displaying location of the machine tool on a predetermined map in a predetermined manner based on location information of the machine tool.

2. The system for managing operating state of a machine tool according to claim 1, wherein the manner of display changes depending on operating state of the machine tool.

3. The system for managing operating state of a machine tool according to claim 1 or 2, wherein, when an alarm is generated in the machine tool, content of the alarm is displayed as well.

4. The system for managing operating state of a machine tool according to claim 1 or 2, wherein operating state of the machine tool is displayed by a predetermined operation.
